(19) United States
(12) Patent Application Publication
(10) Pub. No.: US 2024/0331728 A1
(43) Pub. Date: Oct. 3, 2024

(54) MULTIPLE HEATSINK ARCHITECTURE FOR HAMR MEDIA

(71) Applicant: Seagate Technology LLC, Fremont, CA (US)

(72) Inventors: Wei-Heng HSU, Fremont, CA (US); Yingguo Peng, San Ramon, CA (US); Pin-Wei Huang, Fremont, CA (US); Kai Chieh Chang, Pleasanton, CA (US); Ganping Ju, Pleasanton, CA (US)

(73) Assignee: Seagate Technology LLC, Fremont, CA (US)

(21) Appl. No.: 18/437,449

(22) Filed: Feb. 9, 2024

Related U.S. Application Data
(60) Provisional application No. 63/493,431, filed on Mar. 31, 2023.

(51) Int. Cl. G11B 5/73; G11B 5/00; G11B 5/66

(52) U.S. Cl. CPC G11B 5/7375; G11B 5/66; G11B 2005/0021

(57) ABSTRACT

A data media may generally be configured in accordance with various embodiments with contactingly adjacent first and second heatsink layers that are tuned with a common crystallographic orientation and with different thermal conductivities to provide a predetermined thermal gradient. The data media may further be configured with a recording layer formed with the common crystallographic orientation adjacent the first and second heatsink layers.

This application claims priority to U.S. Provisional patent application Ser. No. 63/493,431, entitled “MULTIPLE HEATSINK ARCHITECTURE FOR HAMR MEDIA” and filed Mar. 31, 2023, the entire contents of which are hereby incorporated by reference.

### BACKGROUND

Heat assisted magnetic recording (HAMR) is designed to increase the areal density of written data by recording data in a magnetic recording medium having higher coercivity than can be written by a magnetic field from a magnetic recording head without assistance. By heating the surface of the magnetic recording medium with a near field transducer (NFT) during write operations, coercivity of the magnetic recording medium is reduced so that the magnetic field of the magnetic recording head can record data in the magnetic recording medium at high areal density. In HAMR, there is a trade-off between areal density capability (ADC), which is positively correlated to thermal gradient in the media, and laser power. To achieve higher thermal gradient in the media, the peak temperature in the recording layers of the media must increase. Increasing the peak temperature in the recording layers of the media can increase the temperature stress on the NFT which may lead to higher failure rate. In addition to the trade-off between ADC and laser power, heat flowback from the heatsink in the media into the recording layers can also degrade the thermal gradient in the media.

### SUMMARY

Various embodiments of the present disclosure are generally directed to a magnetic storage media with tuned heat characteristics during data access operations. In one example, a data media is described. The data media includes a substrate and a stack. The stack includes contactingly adjacent first and second heatsink layers, tuned with a common lattice structure and with different thermal conductivities to provide a predetermined gradient. The first heatsink layer includes W, a W alloy, Rh, an Rh alloy, Mo or an Mo alloy. The second heatsink layer comprises an a WX alloy, an RhX alloy, or an MoX alloy where X is Cr, Ta, Ni, Co, or Fe.

In another example, a stack is described. The stack includes contactingly adjacent first and second heatsink layers, tuned with a common lattice structure and with different thermal conductivities to provide a predetermined gradient. The first heatsink layer comprises W, a W alloy, Rh, an Rh Alloy, Mo, or an Mo alloy. The second heatsink layer comprises an a WX alloy, an RhX alloy, or an MoX alloy where X is Cr, Ta, Ni, Co, or Fe.

### BRIEF DESCRIPTION OF THE DRAWINGS

FIG. 1 is a block representation of an example portion of a data storage device constructed and operated in accordance with various embodiments.

FIG. 2 generally illustrates an example block representation of an example magnetic writing element capable of being used in the data storage device of FIG. 1.

FIG. 3 displays block representations of example portions of a data storage media constructed in accordance with various embodiments.

FIG. 4 graphs operational characteristics of a data storage media constructed in accordance with various embodiments.

FIG. 5 graphs areal density capability (ADC) as a function of laser power for an example data media configured with different heatsink laminations in accordance with various embodiments.

FIG. 6 provides a flowchart of a data media fabrication routine conducted in accordance with various embodiments.

### DETAILED DESCRIPTION

As industry advances data storage devices with higher data capacity and data transfer rates, emphasis is placed on the size and integrity of data bits in a data storage media. Advancements in the use of heat to temporarily modify data bit magnetic coercivity have increased data transfer rates but have also stressed the ability of data media to be quickly heated, such as by a laser in heat assisted magnetic recording (HAMR), without losing data bit programming and reading accuracy. Data media laminations employed in heated applications may be designed and constructed with a heatsink having high thermal conductivity, such as κ>150 W/m-K, that allows heat to engage a particular area of a data media and be quickly dissipated so not to inadvertently effect adjacent data bits.

However, the use of high thermal conductivity heatsink materials, such as Al, Co, Ag, Au, and their alloys, can produce a dominant noise source for the data recording system, especially in increased linear density, reduced form factor data storage devices. Such dominant noise source may be characterized as “media jitter” that can be expressed by the following equation 1:

$${σ}_{j}^{2} = \frac{1}{N} [ {( \frac{Δ {H}_{SW}}{\frac{dH}{dx}} )}^{2} + \frac{{D}^{2}}{12} ] = \frac{1}{N} [ {( \frac{Δ {H}_{K} ( {T}_{write} )}{( \frac{dT}{dx} ) * ( \frac{{dH}_{K}}{dT} )} + \frac{δ {T}_{C}}{\frac{dT}{dx}} )}^{2} + \frac{{D}^{2}}{12} ] \qquad Eq . 1$$

where dT/dx is the thermal gradient, which corresponds to a larger thermal gradient resulting in smaller media jitter.

Although a large thermal gradient may be obtainable by introducing a thermal barrier layer in a data media lamination with bulk materials such as SiO2, MgO, and soft magnetic under-layer (SUL), such a thermal barrier can correspond to higher minimum laser power needed to access a data bit, which may adversely affect data access reliability. Moreover, the use of thermal barrier materials can disrupt the crystallographic orientation of subsequently deposited layers of a data media lamination, such as the magnetic recording layer. As such, a data media lamination with increased thermal gradient and reduced minimum heating power for data access is a continued goal for the industry.

Accordingly, a data media may be configured as a magnetic stack with contactingly adjacent first and second, or multiple laminated, heatsink layers that can each be tuned at least for thickness and material to provide a predetermined crystallographic orientation corresponding to a tuned thermal gradient through the magnetic stack. The ability to tune the thermal gradient of the magnetic stack, and consequently the data media, allows the predetermined crystallographic orientation to be present above the heatsink layers due at least in part to the reduction in thickness or elimination of a thermal resistor layer. That is, each lamination in the layered heatsink can be tuned to provide a thermal gradient that minimizes or eliminates the use of a thermal barrier layer, which allows the data media to be deposited with a crystallographic orientation corresponding to a recording layer that is adapted to different data access operations involving the application of heat.

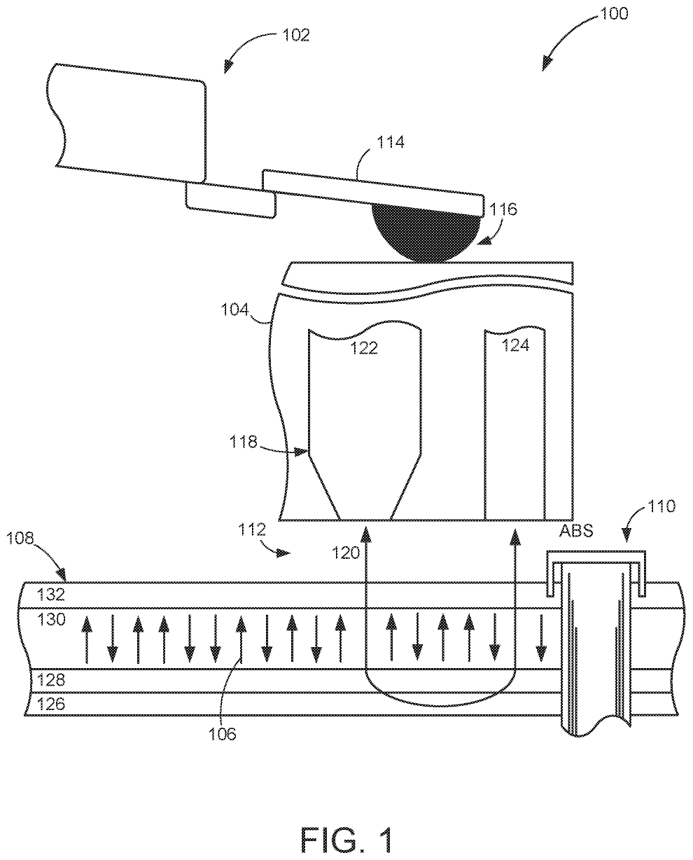

FIG. 1 generally illustrates a block representation of a data access portion 100 of an example data storage device capable of being tuned to a predetermined thermal gradient. While the data access portion 100 is shown in an environment in which various embodiments of the present technology can be practiced, it should be understood, however, that the various embodiments of this disclosure are not so limited by such environment and can be implemented in a variety of data storage devices, such as solid-state data storage applications.

The data access portion 100 has an actuating assembly 102 that positions a transducing head 104 over data bits 106 programmed on a data media 108. The data media 108 is attached to a spindle 110 that can facilitate rotation of the data media 108 to produce an air bearing surface (ABS) 112 on which a slider portion 114 of the actuating assembly 102 flies to position a head gimbal assembly (HGA) 116, which includes at least the transducing head 104, over various predetermined portions of the data media.

While not limiting, the transducing head 104 may include one or more transducing elements, such as a magnetic writer and magnetically responsive reader, which operate to program to and read data from the storage media 108, respectively. In this way, controlled motion of the actuating assembly 102 can correspond with positioning the transducers in close proximity to the data media 108 and in alignment with data tracks (not shown) to write, read, and rewrite data, as generally displayed by the data writing portion 118 of the transducing head 104 producing a magnetic pathway 120 flowing from the write pole 122 through the data media to the return pole 124, or vice versa.

Regardless of the configuration of the write pole 122 and return pole 124, the data writing portion 118 and data media 108 can be respectively constructed and tuned so that the magnetic pathway 120 engages a plurality of layers of the data media 108 immediately after the application of heat. The number, type, and configuration of the various layers of the data media 108 are not limited to a particular design, but the example embodiment of FIG. 1 illustrates a soft magnetic underlayer 126, interlayer structure 128, magnetic recording layer 130, and overcoat 132 successively formed atop one another. Such layer configuration can allow for perpendicular recording of data bits as the magnetic pathway 120 completes a circuit from the write pole 122, across the ABS, and perpendicularly through the magnetic recording layer 130, as shown, or longitudinally.

In applications where heat is used to temporarily change the coercivity of the one or more of the data media 108 layers, the use of a thermal resistor in the interlayer structure 128 provides a large thermal gradient conducive to magnetic recording, but at the cost of disrupting the crystallographic orientation of the subsequently deposited magnetic recording layer 130. Consequently, data media that can be constructed with large thermal gradients and compatible crystallographic orientation throughout the layers may produce increased data capacity and data transfer rates. In other words, the ability to tune the data media 108 specifically for thermal gradient and crystallographic orientation corresponding to the application of heat can allow data bits to be smaller and more tightly packed in the magnetic recording layer 130 without concern for data access difficulties, such as noise associated with media jitter.

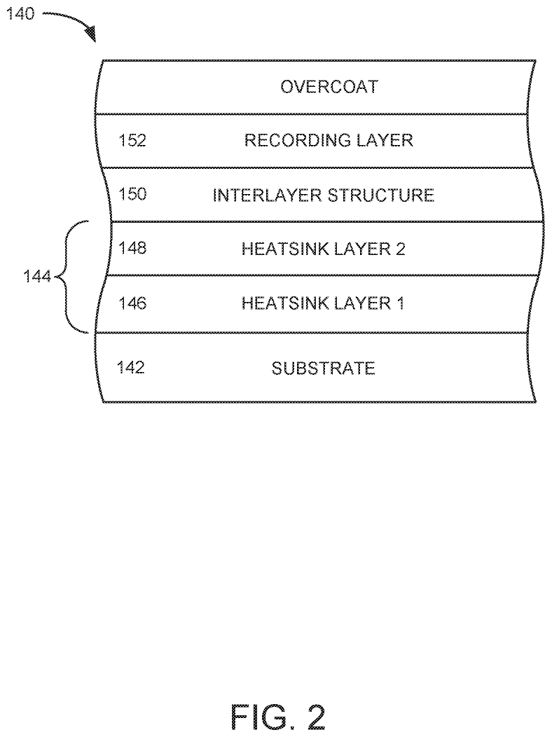

As an example of a data storage lamination capable of providing tuned thermal gradient and crystallographic orientations, FIG. 2 shows a cross-sectional block representation of a portion of an example data media 140 constructed in accordance with various embodiments. The data media 140 can be configured with any number and type of materials deposited in a variety of non-limiting manners, such as sputtering and vapor deposition. In the embodiment shown, a substrate 142 provides a foundation for a heatsink lamination 144 comprising first heatsink layer 146 and second heatsink layers 148 to be positioned between the substrate 142 and an interlayer structure 150.

The use of at least two heatsink layers (for example first heatsink layer 146 and second heatsink layer 148) with complementary crystallographic orientations, such as fcc-fcc and bcc-bcc lattice structures with close lattice constant combinations, that form a single-phase solid solution allows the interlayer structure 150 and subsequently deposited recording layer 152 to maintain the crystallographic orientation that provides a large thermal gradient throughout the data media 140. Adjustment of the thickness and materials of the various heatsink layers 146 and 148 can tune the heatsink lamination 144 and data media 140 to a variety of thermal gradients conducive to different data access operations involving heat, such as varying laser power HAMR applications.

Here after, explanation is provided for a two-layer structure (HS1 & HS2) embodiment, which is a simplified example that can be tuned and optimized with the addition, or removal, of more lamination layers to produce a predetermined thermal gradient profile. While no single heatsink lamination 144 configuration is required or limiting, various embodiments obtain large thermal gradients through the data media 140 by forming the first heatsink layer 146 with a thermal conductivity of approximately 50-300 W/m-K, and the second heatsink layer 148 with a thermal conductivity of approximately 1-50 W/m-K, with a preferred range of 1-20 W/m-K. Such heatsink lamination 144 configuration can correspond to matching the materials of the heatsink layers 146 and 148 to provide the same lattice structures and single-phase solid solution.

By no mean exhaustive, the first heatsink layer 146 may be constructed of a material with high thermal conductivity such as Cu, Ag, Au, W, Mo, Rh and their respective alloys. First heatsink layer 146 is from about 10 nm to about 120 nm thick.

The second heatsink layer 148 may be deposited with an alloy derived from the first heatsink layer 146 to best maintain the matching of the lattice structure while providing a layer with lower thermal conductivity. That is, the alloy selection for the second heatsink layer 148 may be Cu, Ag, Au, W, Mo, Rh, Cr alloyed with, for example, Fe, Cr, Ni, Co, or Ta. In some examples an alloy formed from WX, RhX, or MoX where X is Cr, Ta, Ni, Co or Fe may be used. In some scenarios, formation of a W_{(1-y)}Fe_{y} alloy, a Rh_{(1-y)} Fe_{y} or a Mo_{(1-y)}Fe_{y} (where y=0.02-0.5) for second heatsink layer 148 may provide better growth texture for interlayer structure 150 and recording layer 152. In addition, formation of a W_{(1-y)}Fe_{y}, Rh_{(1-y)}Fe_{y} alloy or Mo_{(1-y)}Fe_{y} (where y=0.02 to 0.5) in second heatsink layer 148 allows for fine-tuning of the thermal conductivity in second heatsink layer 148.

In some examples, dopants may be added during deposition of second heatsink layer 148 to reduce the thermal conductivity of second heatsink layer 148. Example dopants include Fe, Cr, Ni, Co or Ta and may be added in amounts ranging from 2 at % to 50 at % to Mo, Rh, or W or alloys of Mo, Rh or W. Second heatsink layer 148 may range from about 2 nm to about 30 nm thick

In some examples the optical properties of second heatsink layer 148 may also be tuned to provide desired thermal gradient value. In some examples, the refractive index (n) of second heatsink layer 148 and extinction coefficient (k) of second heatsink layer 148 are both tuned to be greater than 1. In examples where the n and the k of second heatsink layer are greater than 1, higher signal-to-noise ratio (SNR) may be achieved at lower laser power.

The wide variety of materials that can be used for the first and second heatsink layers 146 and 148 to provide matched lattice structures and single-phase solid solutions illustrate how the thermal gradient of the data media 140 can be tuned by selection of a predetermined crystallographic orientation in the heatsink lamination 144. The predetermined crystallographic orientation can further reduce or eliminate thermal resistance due to lattice mismatch, which prevents localized epitaxial growth between the heatsink layers 146 and 148 and allows the recording layer 152 to be grown with the predetermined crystallographic orientation.

Interlayer structure 150, is disposed on top of second heatsink layer 148. Interlayer structure 150 may include a layer comprising MgO and TiO or combinations thereof. In some examples interlayer structure 150 is approximately 1 nm to 16 nm thick and includes MgOₓTiO_{y} (where x+y=1).

The ability to tune the material composition of the heatsink layers to provide a heatsink lamination with graded thermal conductivities provides a wide variety of heatsink lamination configurations that can accommodate different heat intensive data access operations. However, material composition is not the only manner of tuning the heatsink lamination as heatsink layer thickness and optical properties can be adjusted to complement the different thermal conductivities and provide a large thermal gradient without inhibiting crystallographic orientation.

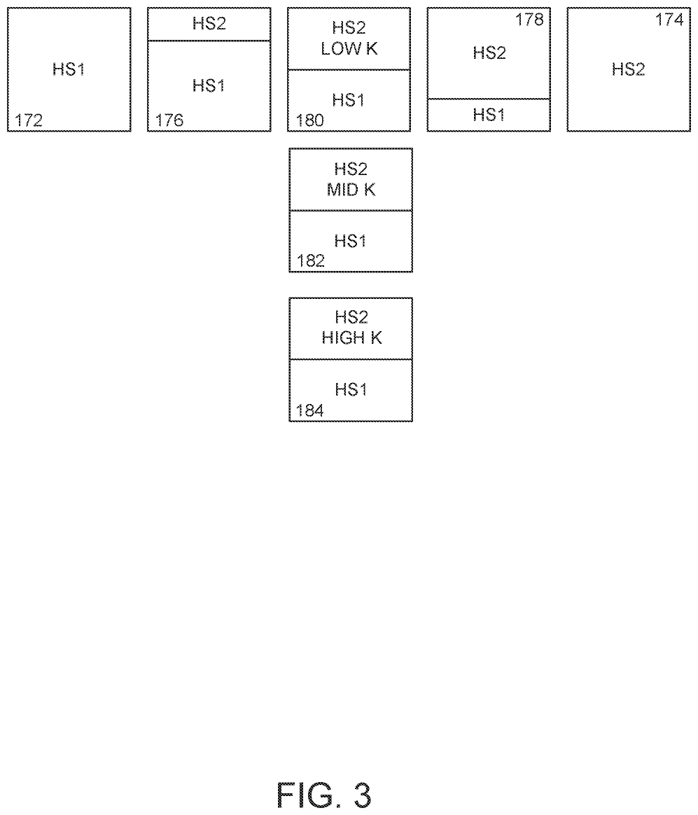

FIG. 3 shows block representations of several example heatsink laminations differently tuned to provide varying thermal gradients in accordance with various embodiments. The heatsink laminations 172 and 174 are formed with a single heatsink layer and each display contrasting heatsink configurations that may be tuned to provide a predetermined thermal gradient. Heatsink laminations 176, 178, and 180 respectively display varying thickness ratios involving first and second heatsink layers (HS1 & HS2), which can accentuate the thermal conductivity of one heatsink layer over another to increase or decrease the overall thermal gradient.

With the heatsink lamination 180, the thickness ratio is further tuned by setting the second heatsink layer to a relatively low thermal conductivity, such as less than 20 W/m-K. The heatsink laminations 182 and 184 respectively display how the same thickness ratio can be adjusted by altering the thermal conductivity of the second heatsink layer to a mid-range, such as approximately 50 W/m-K, and a high-range, like roughly 100 W/m-K. It is to be understood that the various heatsink laminations 172-184 of FIG. 3 illustrate the ability to tune a heatsink lamination for material composition, thickness ratio, optical properties and thermal conductivity to provide a variety of thermal gradients and accommodate the application of wide varieties of heat intensity and duration.

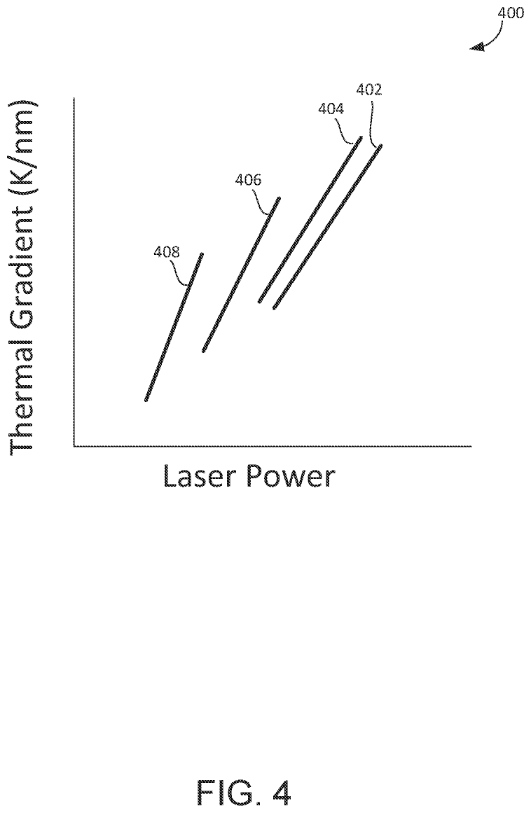

FIG. 4 plots laser power versus thermal gradient for a number of heatsink designs and thicknesses. In plot 400, laser power versus thermal gradient is illustrated for single heatsink design 402, dual heatsink A 404, dual heatsink B 406 and dual heatsink C 408. In the example of FIG. 4 the thermal conductivity of dual heatsink A 404 is greater than the thermal conductivity of dual heatsink B 406 which is greater than the thermal conductivity of dual heatsink C 408. Plot 400 illustrates that for single heatsink design 402, a higher laser power is required to achieve the same thermal gradient, as for example, dual heatsink A 404, dual heatsink B 406 and dual heatsink C 408. In other words, with a dual heatsink design it is possible to have a higher thermal gradient with lower laser power.

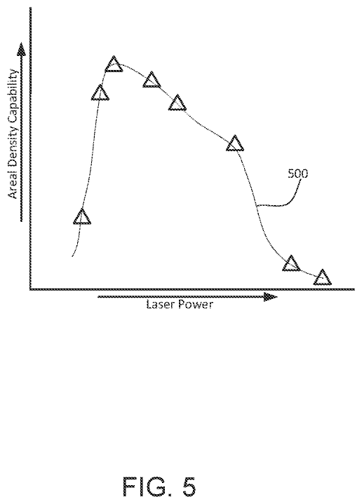

FIG. 5 graphs areal density capability (ADC) as a function of laser power for an example data media configured with different heatsink laminations in accordance with various embodiments (e.g., the heatsink laminations described in relation to FIG. 2). In some examples, forming a heatsink as a single layer may require relatively large laser power for data bit access. Such laser power measurements are not enviable for data media due at least in part to the precise timing of data access operations in HAMR-type applications, which emphasizes the ability to maintain power in a laser.

In the example of FIG. 5, line 500 illustrates ADC as a function of laser power for heatsink laminations configured with tuned thermal conductivities and thickness ratios. The ability to tune the material composition and thickness of heatsink layers (e.g., first heatsink layer 146 and second heatsink layer 148) as well the interlayer (e.g., interlayer structure 150) can accommodate large and small laser power requirements to provide a range of signal to noise ratios. Such diverse operational coverage allows a heatsink lamination to be tuned to precisely match the data transducing components to provide predetermined heat behavior that allows for increased data density and transfer rates.

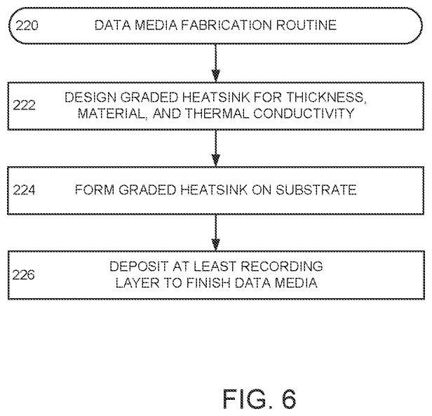

FIG. 6 illustrates an example data media fabrication routine 220 performed in accordance with various embodiments. While not required or limited to a particular means for constructing a data media, data media fabrication routine 220 can begin in some embodiments by designing a graded heatsink lamination in step 222 that exhibits predetermined crystallographic orientation and thermal gradient. As discussed above, design of a graded heatsink lamination can tune the material composition and thickness of a second heatsink layer to produce a thermal conductivity that complements the material composition, thickness, and thermal conductivity of a first heatsink layer to provide a predetermined thermal gradient. The design considerations of step 222 can encompass a range of variables for the respective heatsink layers but should be configured to have matching lattice structures and form a single-phase solid solution.

With the heatsink lamination designed for crystallographic orientation and thermal gradient, step 224 deposits the heatsink layers. The formation of the heatsink layers is not restricted to a particular manner or underlying structure. That is, the heatsink layers can be deposited with manners like oblique deposition sputtering and physical vapor deposition on an underlying substrate, seed, and adhesion layer that may promote heatsink material growth. Step 226 next constructs at least the magnetic recording layer atop the heatsink layers to finish the fabrication of the data media. Formation of the recording layer and any other protective layers, such as an overcoat, are similarly open a variety of deposition manners and underlying structures as was the construction of the heatsink layers.

As an example, step 226 may deposit a thin thermal resistor layer atop the heatsink layers and subsequently form a seed, magnetic recording, and overcoat layer on the thermal resistor. The use of intervening seed layer and thermal resistor may provide additional thermal gradient tuning without inhibiting the crystallographic orientation provided by the heatsink layers due to their thin thickness relative to the heatsink and magnetic recording layers.

Through the various decisions and steps of data media fabrication routine 220, a data media can be fabricated with precisely tuned structural properties that provide predetermined operational heat characteristics. Such tuning can allow for the use of heat for data access operations without inhibiting the ability to increase data storage capacity and data transfer rates. However, data media fabrication routine 220 is not limited to that shown in FIG. 6 as the various steps can be omitted, changed, and added. For example, evaluation and design of a second heatsink layer can be conducted after the deposition of the first heatsink layer to allow for precise matching of actually formed material composition and thickness.

It can be appreciated that the tuned material and operational characteristics of a data media described in the present disclosure allows for broad applicability to accommodate a variety of different heat-centric data access systems. The ability to tune the first and second heatsink layers for thermal conductivity allows for reduced heater power to access data with increased signal-to-noise ratio. Moreover, the matching of lattice structures in a single phase solid solution between the heatsink layers provides a thermal gradient that reduces or eliminates the use of thermal resistor material that disrupts crystallographic orientation continuity between the heatsink layers and a subsequently formed recording layer.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. For example, the particular elements may vary depending on the particular application without departing from the spirit and scope of the present technology.

What is claimed is:

1. A data media comprising:
a substrate; and
a stack wherein the stack comprises contactingly adjacent first and second heatsink layers tuned with a common lattice structure and with different thermal conductivities to provide a predetermined thermal gradient, wherein;
the first heatsink layer comprises W, a W alloy, Rh, an Rh Alloy, Mo, or an Mo alloy; and
the second heatsink layer comprises a WX alloy, an RhX alloy, or an MoX alloy where X is Cr, Ta, Ni, Co, or Fe.

2. The data media of claim 1, wherein the thermal conductivity of the first heatsink layer is approximately 50-150 W/m-K.

3. The data media of claim 1, wherein the thermal conductivity of the first heatsink layer is 50-300 W/m-K.

4. The data media of claim 1, wherein the thermal conductivity of the second heatsink layer is approximately 1-20 W/m-K.

5. The data media of claim 1, wherein the thermal conductivity of the second heatsink layer is approximately 1-50 W/m-K.

6. The data media of claim 1, wherein the second heatsink layer further comprises a second material not present in the first heatsink layer.

7. The data media of claim 1, wherein the first and second heatsink layers are formed as a single phase solid solution.

8. The data media of claim 1, comprising a recording layer formed with the common lattice structure adjacent the first and second heatsink layers.

9. The data media of claim 1, wherein the common lattice structure is an fcc-structure.

10. The data media of claim 1, wherein the common lattice structure is a bcc-structure.

11. The data media of claim 1, wherein the WX alloy, the MoX alloy or the RhX alloy contains between 5% and 50% X.

12. The data media of claim 1 wherein the WX alloy, the MoX alloy or the RhX alloy has an extinction coefficient of greater than 1.

13. The data media of claim 1 wherein the WX alloy, the MoX alloy or the RhX alloy alloy has a refractive index of greater than 1.

14. A stack comprising:
contactingly adjacent first and second heatsink layers tuned with a common lattice structure and with different thermal conductivities to provide a predetermined thermal gradient, wherein;
the first heatsink layer comprises W, a W alloy, Rh, an Rh Alloy, Mo, or an Mo alloy; and
the second heatsink layer comprises a WX alloy, an RhX alloy, or an MoX alloy where X is Cr, Ta, Ni, Co, or Fe.

15. The stack of claim 14, wherein a first thickness of the first heatsink layer is less than a second thickness of the second heatsink layer.

16. The stack of claim 14, wherein a first thickness of the first heatsink layer is greater than a second thickness of the second heatsink layer.

17. The stack of claim 14, wherein the thermal conductivity of the first heatsink layer is 50-300 W/m-K.

18. The stack of claim 14, wherein the thermal conductivity of the second heatsink layer is approximately 1-50 W/m-K.

19. The stack of claim 14, wherein the second heatsink layer further comprises a second material not present in the first heatsink layer.

20. The stack of claim 14, wherein the first and second heatsink layers are formed as a single phase solid solution.
